(19) United States
(12) Patent Application Publication
(10) Pub. No.: US 2026/0011322 A1
(43) Pub. Date: Jan. 8, 2026

(54) SYSTEM AND METHOD FOR STORYTELLING EXPERIENCE

(71) Applicant: Universal City Studios LLC, Universal City, CA (US)

(72) Inventors: Robert Michael Jordan, Orlando, FL (US); Sarah Braeger, Titusville, FL (US)

(21) Appl. No.: 18/763,493

(22) Filed: Jul. 3, 2024

(51) Int. Cl. G10L 15/18; G06V 40/20

(52) U.S. Cl. CPC G10L 15/1815; G06V 40/20

(57) ABSTRACT

A non-transitory computer readable medium stores instructions that, when executed by processing circuitry, cause the processing circuitry to receive data representative of speech, perform natural language understanding (NLU) on the received data to determine a semantic meaning of the speech, perform a sentiment analysis on the received data to determine a sentiment of the speech, providing an input to a large language model (LLM) that includes the received data, the determined semantic meaning of the speech, the determined sentiment of the speech, or any combination thereof, receive a visualization from the LLM based on the input, and cause the visualization generated by the LLM to be displayed.

### BACKGROUND

The present disclosure relates generally to creating an environment that enables guests to describe their experiences at one or more attractions.

For operators of amusement parks or other attractions, obtaining authentic guest satisfaction and/or feedback data may be difficult. Participation in voluntary surveys may be modest and guests that do participate tend to be those that have particularly positive or negative experiences, representing guest experiences at the edges of a bell curve of guest experience, rather than experience of the median or average guest. Further, rather than a unitary memento or keepsake that is representative of their entire experience at the amusement park or attraction, guests may be left with a series of pictures and/or videos captured during their time at the amusement park or attraction, as well as any merchandise or souvenirs they purchased during their time at the amusement park or attraction. Accordingly, techniques for obtaining authentic guest satisfaction and/or feedback data from guests, and providing guests with a memento or keepsake that is representative of their entire experience at the amusement park or attraction are needed.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In an embodiment, a system for creating a storytelling experience includes a microphone that collects data representative of speech in a partially or fully enclosed space, a display that displays visualizations in the enclosed space, a speaker that plays audio in the enclosed space, and a computing device. The computing device includes processing circuitry and memory, accessible by the processing circuitry. The memory stores instructions that cause the processing circuitry to receive the data representative of the speech from the microphone, perform natural language understanding (NLU) on the received data to determine a semantic meaning of the speech, perform a sentiment analysis on the received data to determine a sentiment of the speech, provide an input to a large language model (LLM) that includes the received data, the determined semantic meaning of the speech, the determined sentiment of the speech, or a combination thereof, and receive an output from the LLM that includes a visualization and corresponding audio generated by the LLM based on the input. The visualization is displayed in the enclosed space via the display and the audio generated by the LLM is played in the enclosed space via the speaker.

In an embodiment, a non-transitory computer readable medium stores instructions that, when executed by processing circuitry, cause the processing circuitry to receive data representative of speech in a partially or fully enclosed space, perform natural language understanding (NLU) on the received data to determine a semantic meaning of the speech, and perform a sentiment analysis on the received data to determine a sentiment of the speech. The instructions, when executed by the processing circuity, also cause the processing circuitry to provide an input to a large language model (LLM) that includes the received data, the determined semantic meaning of the speech, the determined sentiment of the speech, or any combination thereof. Further, the instructions, when executed by the processing circuitry, cause the processing circuitry to receive a visualization from the LLM based on the input, and cause the visualization generated by the LLM to be displayed in the enclosed space via a display.

In an embodiment, a method includes receiving an image of a guest having an experience from a mobile device, receiving data representative of speech describing the experience, performing natural language understanding on the received data to determine a semantic meaning of the speech, and performing a sentiment analysis on the received data to determine a sentiment of the speech. Further, the method includes providing an input including the received image, the received data, the determined semantic meaning of the speech, the determined sentiment of the speech, or any combination thereof to a large language model (LLM). Additionally, the method includes receiving a visualization including the image from the LLM, and causing the visualization generated by the LLM to be displayed in an enclosed space via a display.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an amusement park, in accordance with an embodiment of the present disclosure;

FIG. 2 is a schematic illustrating a storyteller’s lounge within the amusement park of FIG. 1, in accordance with an embodiment of the present disclosure;

FIG. 3A illustrates a screen of an application running on a mobile device displaying a notification asking whether to allow the application to access media on the mobile device, in accordance with an embodiment of the present disclosure;

FIG. 3B illustrates a screen of the application running on the mobile device of FIG. 3A that appears once the access to the media has been initiated, in accordance with an embodiment of the present disclosure;

FIG. 4 is a block diagram of example components of a computing device that could be used as the mobile device of FIG. 3, a computing device of the storyteller’s lounge of FIG. 2, and/or a cloud/remote server, or some other device within the amusement park of FIG. 1, in accordance with an embodiment of the present disclosure; and

FIG. 5 is a flow chart illustrating an embodiment of a process for facilitating a storytelling experience, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 percent of a target, within 1 percent of a target, within 5 percent of a target, within 10 percent of a target, within 25 percent of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure is directed to techniques for creating a storytelling experience for a guest visiting an amusement park. During his or her visit to the amusement park, the guest may visit a storyteller’s lounge. Once inside the storyteller’s lounge, the guest describes experiences the guest has had at the amusement park. The experiences may include, for example, rides ridden, attractions visited, characters met, food eaten, and so forth. As the guest speaks, a microphone and/or an imaging system (e.g., a camera) may record audio and/or video of the guest. A computing device receives the audio and/or video of the guest and generates visualizations and/or audio that may be displayed and/or projected within the storyteller’s lounge to enhance the storytelling experience and prompt the guest to continue describing their visit to the amusement park. The computing device may be configured to perform voice analysis and/or natural language understanding (NLU), sentiment analysis, and/or gesture analysis on the audio, video, and/or other data collected (e.g., via cameras, imaging sensors, microphones, and/or other sensors) as the guest speaks and stored in memory. The computing system may have access to other data that may be used to generate the visualizations and/or audio. For example, the computing device may have access to data collected from a storyteller’s booth, which may be a scaled down version of the storyteller’s lounge that lacks the capability to generate and project visualizations and/or audio, but collects data from a guest describing an experience during their visit to the amusement park. The computing device may also have access to context data, which may include, for example, information related to the guest collected during the guest’s visit to the amusement park, such as when the guest checked into a queue to ride a ride, reserved tickets for a show, or ordered food. Such context data may also include, for example, merchandise purchases, an order of attractions visited, and so forth. Further, the computing device may have access to media associated with the guest, either from imaging systems in the amusement park (e.g., cameras mounted along rides to capture images of guests riding rides that guests can purchase, cameras carried by photographers to take portraits of groups of guests and/or guests meeting characters), or from photographs, video, and/or audio stored on a guest’s mobile device to which the guest grants access via a mobile application running on the mobile device.

The collected data, as well as the results of various processing operations, may be provided as inputs to a large language model (LLM), which may generate and output the visualizations and/or audio projected in the storyteller’s lounge as the guest speaks. The LLM may also be configured to output one or more keepsakes (e.g., a video, an image, a sticker, a calendar, a book, a shirt, a hat, a pin, and so forth) for the guest to take with them to remember their trip to the amusement park. Further, the LLM may be configured to generate anonymized guest satisfaction data that identifies an aspect of the guest’s visit to the amusement park and an indication of the guest’s satisfaction with the aspect of the visit to the amusement park indicated by the guest’s description.

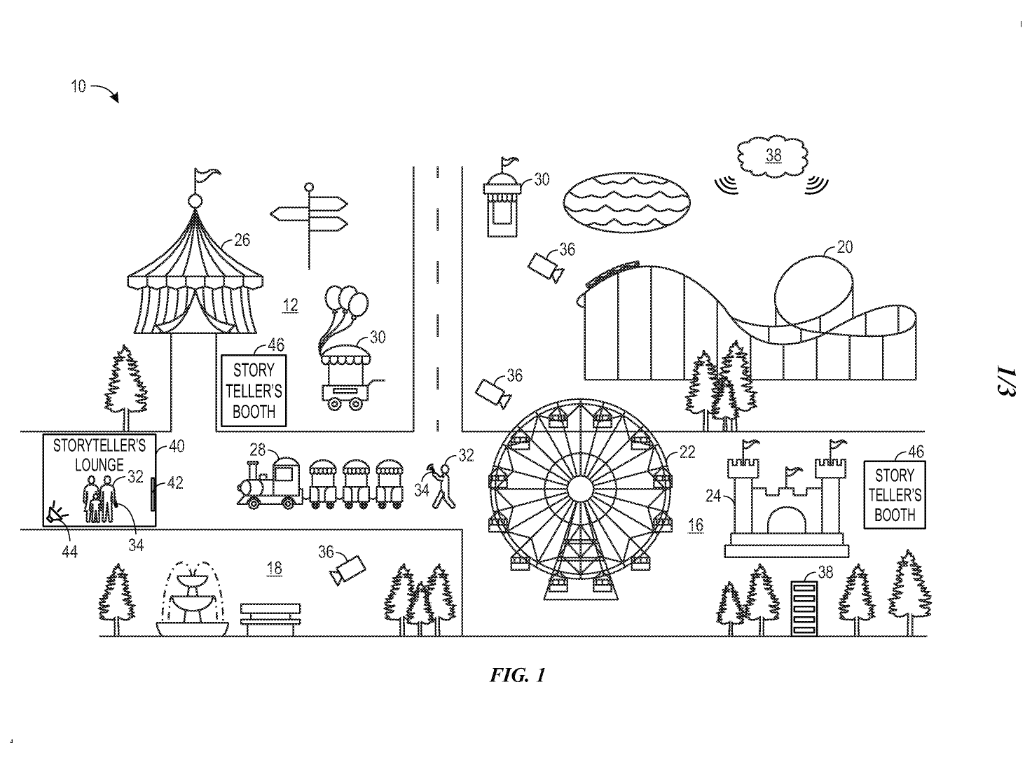

FIG. 1 is a schematic of an amusement park 10. The amusement park 10 may include and/or be separated into one or more sections or lands, such as a first land 12, a second land 14, a third land 16, and a fourth land 18. Each of the lands 12, 14, 16, 18 may include one or more attractions. As shown in FIG. 1, the attractions may include rides, such as roller coasters 20, carousels 22, or attractions in which a guest is moved through an environment, environments through which guests walk, such as castles 24, performance venues 26, restaurants, and so forth. The amusement park may also include transportation 28, such as trams, trains, trolleys, and so forth that are configured to move guests within or between lands 12, 14, 16, 18 of the amusement park 10. Further, the amusement park may include one or more vending locations 30. The vending locations 30 may be stationary (e.g., a storefront), mobile (e.g., a cart, a vendor on foot), or semi-mobile (e.g., a stand), and configured to sell items, such as food, merchandise, toys, souvenirs, toiletries, and so forth to guests.

A guest 32 visiting the amusement park 10 may utilize a mobile device 34 (e.g., a smartphone, tablet, etc.) equipped with a mobile application or configured to access a webpage to perform various tasks while inside the amusement park 10. For example, the guest 32 may utilize the mobile device 34 to join a virtual queue to experience an attraction, place an order for food, order or reserve merchandise or souvenirs, participate in promotions (e.g., give-aways, special edition merchandise releases, etc.) within the amusement park 10, attend, join a queue for, or reserve tickets for events within the amusement park 10, signup to receive messages (e.g., related to weather, safety, attractions being closed, etc.) intended for guests 32, and so forth. While the guest 32 is visiting the amusement park 10, the guest 32 may also utilize the mobile device 34 to capture pictures or video of themselves, their family, and/or other guests with whom they are visiting the amusement park 10.

As shown, the amusement park 10 may include imaging systems 36, which may be used to provide photography services to guests 32. For example, mounted imaging systems 36 may be used to capture images of guests while experiencing an attraction, such as the roller coaster 20. Further, photographers (e.g., professional photographers) may also be equipped with imaging systems 36 and move throughout the amusement park 10 capturing images of guests 32 enjoying the amusement park 10, meeting characters, and so forth. Upon capture, images may be transmitted to and/or stored on one or more servers 38, which may be accessible by the application running on the mobile device 34, such that guests 32 may be able to view and/or purchase captured images (e.g., at a vending location 30 or on their mobile device 34) throughout their visit or for some period of time after leaving the amusement park 10.

As is described in more detail below, the amusement park 10 may include one or more storyteller’s lounges 40, which may be situated near the egress of the amusement park 10, near the egress of a land 12, 14, 16, 18, near the egress of an attraction, or in other locations throughout the amusement park 10. One or more guests 32 may enter the storyteller’s lounge 40 and describe one or more experiences at the park. The guest 32 may be prompted by a storytelling guide (e.g., an employee of the amusement park 10), written prompts (e.g., displayed on a screen, on a wall, on a sign, etc.), audio prompts (e.g., played over a speaker), visual prompts (e.g., displaying images associated with certain attractions or features of the amusement park), or the guest may begin speaking without prompting. An imaging system and/or a microphone in the storyteller’s lounge 40 may be used to record audio of the description and/or record video of the guest 32 while describing the experience. The storyteller’s lounge 40 may include a display 42 configured to display visualizations and/or speakers 44 configured to project audio generated in response to the guest’s 32 description. As will be described in more detail below, in some embodiments, the visualizations and/or audio may be generated using artificial intelligence (AI) and based on images and/or audio stored on the server 38, which may or may not be unique to the guest 32. Further, in some embodiments, the guest 32 may grant access to images, video, and/or audio files captured during their visit to the amusement park 10 and stored on a mobile device 34. These files may be accessed from the mobile device 34 or uploaded to the server 38.

In some embodiments, the amusement park 10 may also include one or more storyteller’s booths 46, which may be similar to the storyteller’s lounge 40, but with fewer features than the storyteller’s lounge 40. For example, in some embodiments, the storyteller’s booth 46 may be configured to collect audio and/or images of a guest 32 describing an experience, but not configured to display visualizations and/or play audio generated in response to the guest 32 describing the experience. Accordingly, the storyteller’s booth 46 may be configured for the guest 32 to enter and provide a description of experiences one or more times during their visit to the amusement park 10. Photos, video, audio, and other data may be collected from time spent in the storyteller’s booth 46 and then transmitted to the server 38 such that the photos, video, audio, and other data can be retrieved from the server 38 and used to generate visualizations and or audio when the guest 32 visits the storyteller’s lounge 40 before departing the amusement park 10.

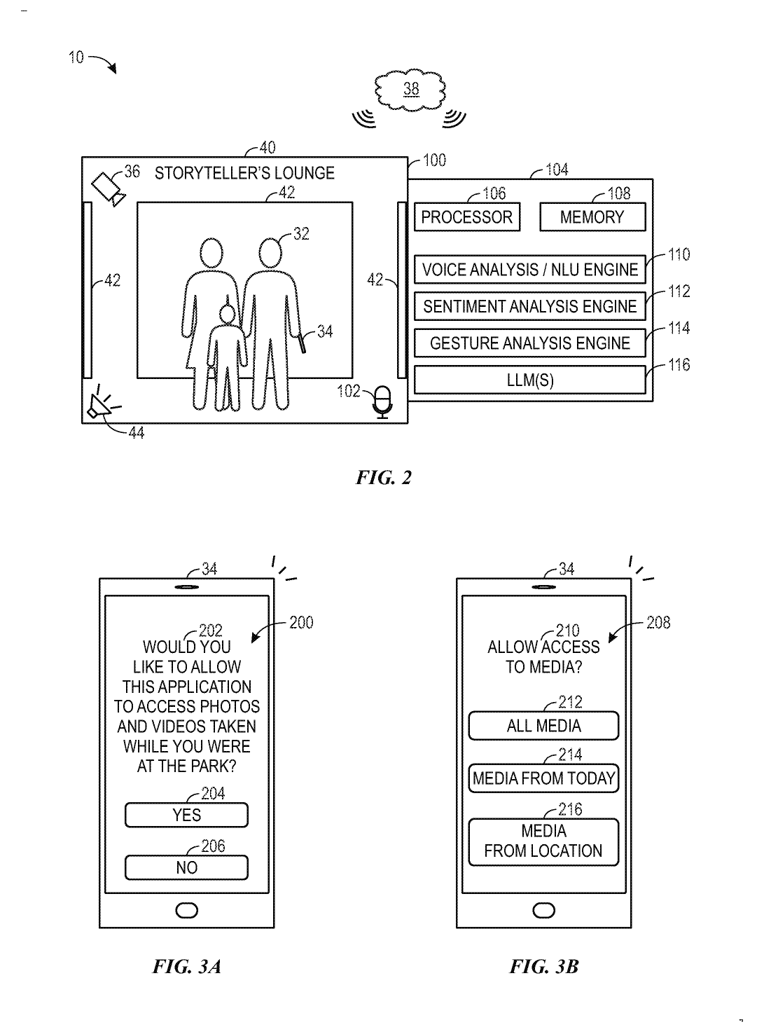

FIG. 2 is a more detailed schematic of the storyteller’s lounge 40 of FIG. 1. As shown, the storyteller’s lounge 40 may be a room, a building, or some other housing 100 (e.g., defining a partially or fully enclosed space). The storyteller’s lounge 40 may be equipped with one or more imaging systems 36 and/or one or more microphones 102 configured to collect audio, video, images, and other data (e.g., motion detection, gesture detection, sentiment detection, etc.) as one or more guests 32 speak (e.g., describe an experience). A computing device 104 may receive collected data from the imaging systems 36 and/or microphones 102, process the received data, and generate visualizations to be displayed via the one or more displays 42 and/or audio to be projected by the one or more speakers 44. In some embodiments, the displays 42 may include one or more virtual reality (VR) and/or augmented reality (AR) displays/headsets. The guest 32 may utilize an application running on their mobile device 34 to upload or grant access to photos, videos, audio files, and other data collected while visiting the amusement park 10. The computing device 104 may incorporate the photos, videos, audio files, and other data from the mobile device 34 into the generated visualizations and/or audio projected while the guest 32 is in the storyteller’s lounge 40. For example, video taken from a certain part of the amusement park 10, such as video of the guests 32 walking toward an attraction before riding the attraction, video of the guests 32 exiting the attraction after riding the attraction, a picture of the guests 32 meeting a character, a picture of the guests eating food, and so forth, may be shown on the display 42 as the guest 32 describes those experiences. In some embodiments, photos, videos, audio files, and other data from imaging systems 36 within the park and/or from the guest’s 32 mobile device 34 may be displayed to prompt the guest to describe an experience.

As shown, the computing device 104 may include a processor 106 and a memory 108. The memory 108 may store data, as well as program instructions that, when executed by the processor 106, cause the processor 106 to perform operations defined by the instructions. The computing device 104 may run a voice analysis/natural language understanding (NLU) engine 110, a sentiment analysis engine 112, a gesture analysis engine 114, and one or more large language models (LLMs) 116. As used herein, an LLM is a computational model capable of natural language understanding, natural language processing, and language generation. LLMs learn statistical relationships from text during supervised, semi-supervised, and/or unsupervised training processes that enable the LLM to perform the above-mentioned tasks. Typically, LLMs receive and input, process the input, and generate an output. Though FIG. 2 shows the voice analysis/NLU engine 110, the sentiment analysis engine 112, the gesture analysis engine 114, and the one or more LLMs 116 as running on the computing device 104, in some embodiments, these components may run on other computing devices, such as an on-premises (“on-prem”) server, a remote server, a cloud server, and so forth and be accessible by the computing device 104.

The voice analysis/NLU engine 110 receives audio from the guest 32 speaking, a transcription of the guest 32 speaking, and/or other data collected while the guest 32 is speaking and utilizes voice analysis and/or NLU algorithms and/or rule sets to determine the semantic meaning of what the guest is saying. For example, the voice analysis/NLU engine 110 may be configured to identify people, places, things, attractions, amusement park 10 features etc. that the guest 32 is speaking about, identify what the guest is saying about the identified things, such as whether the guest enjoyed something, did not enjoy something, was surprised by something, was scared by something, did not understand something, and so forth. The voice analysis/NLU engine 110 may be capable of determining the meaning of what the guest is saying and adjust the generated visualizations and/or audio to reflect what is being said. The voice analysis/NLU engine 110 may utilize one or more artificial intelligence-based algorithms and/or LLMs, which may be trained on training data that includes semantic meanings of commonly used words, as well as semantic meanings of terms that might be specific to, or more commonly used with regard to the amusement park 10.

The sentiment analysis engine 112 receives audio from the guest 32 speaking and/or other data collected while the guest 32 is speaking and applies one or more algorithms and/or rule sets to determine the sentiment of the guest 32 as the guest is speaking (e.g., what are the feelings of the guest being communicated as the guest speaks). Determining sentiment may be based on words used, tone of voice, intonation, other noises made, and so forth. For example, the sentiment analysis engine 112 may determine whether the guest is happy, sad, excited, scared, nervous, anxious, sarcastic, silly, bored, etc. In some embodiments, the sentiment analysis engine 112 may also determine the degree to which the guest is expressing emotions. For example, the sentiment analysis engine 112 may be capable of determining a degree of excitement as the guest 32 is speaking and adjust the generated visualizations and/or audio to reflect the emotions being communicated and the degree of those emotions. The sentiment analysis engine 112 may also be used to identify a climax of the guest’s description, important events in the guest’s description, a priority of events being discussed, and so forth. The sentiment analysis engine 112 may utilize one or more artificial intelligence-based algorithms and/or LLMs, which may be trained on training data that includes sentiments associated with commonly used words or sequences of words, tones of voice, intonations, non-word noises, etc., as well as sentiments associated with terms that might be specific to, or more commonly used with regard to the amusement park 10.

The gesture analysis engine 114 may use the imaging systems 36 to collect video data or other imaging data related to movements of the guest 32 to identify gestures and/or other movements of the guest 32. Gestures may supplement the meaning of what the guest 32 says as they speak and/or the sentiment determined by the sentiment analysis engine 112. For example, increasing arm movement of the guest 32 or the guest jumping as they speak may be indicative of increased excitement. Accordingly results from the gesture analysis engine 114 may be used to adjust the generated visualizations and/or audio. The gesture analysis engine 114 may utilize one or more artificial intelligence-based algorithms and/or LLMs, which may be trained on training data that includes the meanings and/or sentiments associated with commonly used gestures, as well as meanings and/or sentiments associated with gestures that might be specific to, or more commonly used with regard to the amusement park 10.

Data from the imaging systems 36 and microphones 102, data collected from previous visits to the storyteller’s lounge 40 or a storyteller’s booth, data collected from imaging systems 36 disposed throughout the amusement park 10, and data collected from the mobile device 34, as well as outputs from the voice analysis/NLU engine 110, the sentiment analysis engine 112, and/or the gesture analysis engine 114, may be provided as inputs to the one or more LLMs 116. The one or more LLMs 116 may generate visualizations and/or audio to be displayed on the displays 42 and/or speakers 44 in the storyteller’s lounge 40 as the guest 32 speaks to provide inspiration to the guest 32 and supplement the guest’s speech for other guests 32 in the group (e.g., friends, family members, etc.). For example, as the guest 32 speaks about their experience at a particular attraction in the amusement park 10, the LLM 116 may generate visualizations that incorporate colors associated with the attraction, images of characters, objects, icons, or other imagery associated with the attraction, and/or reflect the sentiment being used by the guest. In some embodiments, the visualizations may include images or video of the guest 32 at the attraction provided by the guest’s mobile device 34, or captured by imaging systems 36 in the amusement park 10. Further, in some embodiments, data collected from the guest’s 32 visit to the amusement park 10, such as what attractions the guest checked into and when, the order of attractions visited, purchases made during the guest’s 32 visit to the amusement park 10, and so forth may be used to create a timeline for the guest’s 32 visit to the amusement park 10, which may provide a framework for the generated visualizations and audio. The visualizations may also incorporate stock images, videos, animations, templates, and so forth that may be associated with the attraction or other aspects of the amusement park 10 and stored in memory 108 or on a server. The LLM 116 may also generate audio to be played with the visualizations. The audio may correspond to the sentiment used by the guest (e.g., suspenseful, building to a crescendo, joyful, elegant, etc.) and include audio (e.g., excited screams from a roller coaster) pulled from video provided by the guest’s mobile device 34 or captured by imaging systems 36 in the amusement park 10, as well as audio files provided by the guest’s mobile device 34. As previously described, the audio and visualizations created by the LLM 116 may be shown on the one or more displays 42 and projected by the speakers 44 in the storyteller’s lounge 40 as the guest 32 is describing their experience.

As previously described, a guest 32 may visit the storyteller’s lounge 40, a storyteller’s booth, or a combination thereof, multiple times during a visit to the amusement park 10 to provide a description of experiences the guest 32 has during their visit. The guest 32 may visit the storyteller’s lounge 40 toward the end of their visit to the amusement park 10, or toward the end of a day of a visit to the amusement park 10 to provide a final description of their visit or day at the amusement park 10 and experience visuals and audio generated based on the provided description(s). If the guest’s visit to the amusement park 10 spans multiple days, the guest 32 may visit the storyteller’s lounge 40 at the end of each day, at the end of their visit, or some combination thereof to experience visuals and audio generated for the current day, for the time since their previous visit to the storyteller’s lounge 40, or for their entire visit to the amusement park 10, which may span multiple days.

In an embodiment, the computing device 104 may be configured to generate a keepsake for the guest 32 to take as a memento to remember their visit to the amusement park 10. For example, the computing device 104 may generate a video file that includes visualizations and/or audio. The visualizations and audio may be the same visualizations and audio displayed on the displays 42 and projected by the speakers 44 in the storyteller’s lounge 40 or different from the visualizations and audio displayed on the displays 42 and projected by the speakers 44 in the storyteller’s lounge 40. In some embodiments, the video file may or may not include video and/or audio of the guest 32 describing their experience. The video file may be made available to the guest 32 via the application running on the mobile device 34 (e.g., via a server), via a hyperlink, via text or email, via a tangible storage medium (e.g., a disk, a thumb drive, etc.), or some other mechanism, thus allowing the guest 32 to show or send the video to friends and family, post the video to social media, and so forth. In some embodiments, the keepsake may be one or more images (e.g., a slide show or photo album) that may be accessible via the mobile device or physical printed images. The keepsake may also include a file representing a VR or AR experience or environment. In some embodiments, the keepsake may be a physical object, such as stickers, a calendar, a scrapbook or bound book, a shirt, a hat, some other article of clothing, a pin, and so forth.

The computing device 104 may also utilize collected data to generate anonymized guest satisfaction data. For example, the computing device 104 may analyze collected data (e.g., data collected from the imaging system 36 and microphone 102 inside the storyteller’s lounge 40, as well as imaging systems 36 disposed throughout the park, data extracted from or included in photos, video, and audio provided via the guest’s mobile device 34, as well as data from attraction check-ins, orders placed, and so forth during the guest’s visit to the amusement park 10) to identify what the guest 32 did at the amusement park 10, how the guest felt, and, in some cases, the degree of their feelings. For example, if the guest 32 described riding a particular roller coaster and that it was their favorite thing the guest 32 did that day, the computing device 104 may recognize that and generate guest satisfaction data that includes a tag for the identified attraction and/or amusement park 10 feature, and a rating or score of the guest’s 32 satisfaction with the attraction or feature. In some embodiments, the generated data may be anonymized to obscure the guest’s identity such that a person with access to the guest satisfaction data would be unable to identify the guest 32 associated with particular guest satisfaction data.

FIGS. 3A-3B illustrate screens of a mobile application, which may run on the mobile device 34 shown in FIGS. 1 and 2. FIG. 3A illustrates a screen 200 of an application displaying a notification 202 asking whether the guest would like to allow the application to access media on the mobile device 34 taken while at the amusement park. As previously described, during the guest’s visit to the amusement park, the guest may use the mobile device 34 to take video, still images, record audio, and/or other media of the guest and/or other people in the guest’s party experiencing the amusement park. Accordingly, the guest may use the mobile application running on the mobile device 34 to grant access to the video, still images, recorded audio, and/or other media to be incorporated into the visualizations and audio generated for display in the storyteller’s lounge and/or incorporated into the keepsake provided to the guest. However, before the media is retrieved from the mobile device 34, the screen 200 of the mobile device may display a notification 202 asking whether the guest wishes to allow the application to access media stored on the mobile device 34. The screen 200 may include a “yes” button 204 that, when selected, initiates access to the media stored on the mobile device 34, and a “no” button 206 that, when selected, prevents the application from accessing media stored on the mobile device 34.

FIG. 3B illustrates a screen 208 of the application that appears once the access to media has been initiated. As shown, the screen 208 displays a notification 210 asking the guest to identify which media stored on the mobile device 34 should be made accessible. For example, the screen 208 may include options for allowing access to all media (212), allowing access to media from that day (214), and allowing access to media from a specific location (216) (e.g., the amusement park), and so forth.

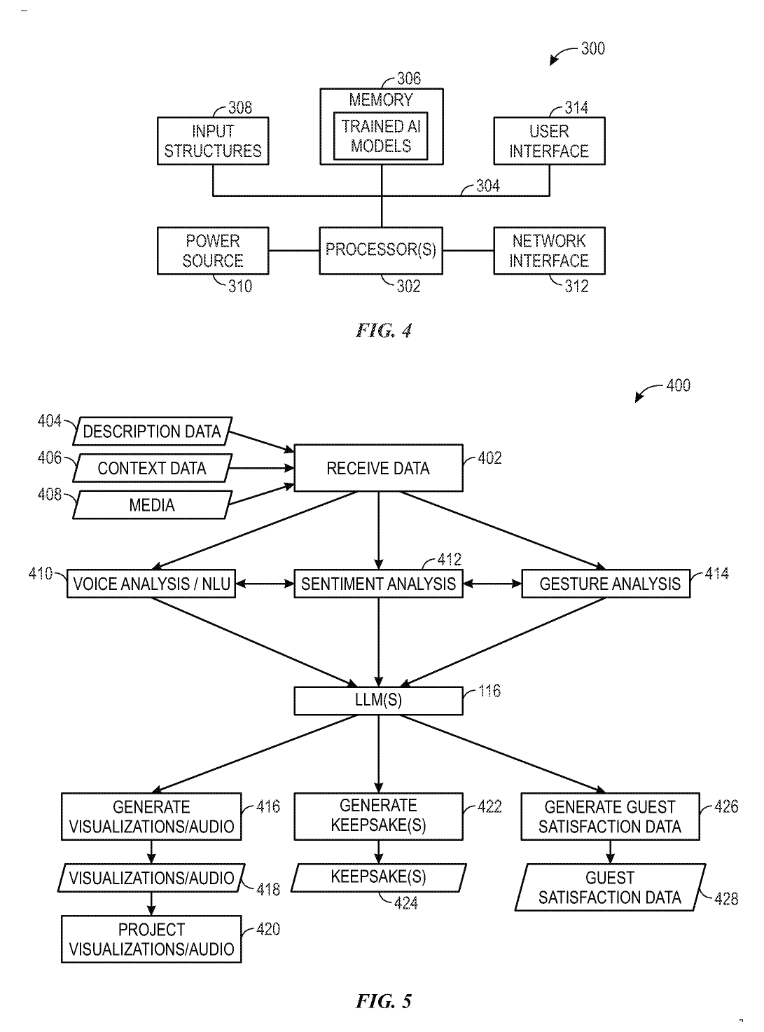

FIG. 4 illustrates a block diagram of example components of a computing device 300 that are configured to be used as the mobile device 34, the server 38, and/or the computing device 104, or some other device within the amusement park 10 shown in FIGS. 1 and 2. As used herein, a computing device 300 may be implemented as one or more computing systems including laptop, notebook, desktop, tablet, or workstation computers, as well as server type devices, network devices, such as routers, switches, edge devices, etc., or portable, communication type devices, such as cellular telephones and/or other suitable computing devices.

As illustrated, the computing device 300 includes various hardware components, such as one or more processors 302, one or more busses 304, memory 306, input structures 308, a power source 310, a network interface 312, a user interface 314, and/or other computer components useful in performing the functions described herein.

The one or more processors 302 (e.g., processing circuitry) may include, in certain implementations, microprocessors configured to execute instructions stored in the memory 306 or other accessible locations. Alternatively, the one or more processors 302 may be implemented as application-specific integrated circuits (ASICs), field-programmable gate arrays (FPGAs), and/or other devices designed to perform functions discussed herein in a dedicated manner. As will be appreciated, multiple processors 302 or processing components may be used to perform functions discussed herein in a distributed or parallel manner.

The memory 306 may encompass any tangible, non-transitory medium for storing data or executable routines. Although shown for convenience as a single block in FIG. 4, the memory 306 may encompass various discrete media in the same or different physical locations. The one or more processors 302 may access data in the memory 306 via one or more busses 304. For example, the memory 306 may include store software instructions that may be retrieved and executed by the one or more processors 302. The memory may also store trained AI-based algorithms and/or models, as well as data that may be retrieved and/or processed by the processors using the software instructions and/or the AI-based algorithms. In some embodiments, the various components may communicate with one another wirelessly.

The input structures 308 may allow a user to input data and/or commands to the device 300 and may include mice, touchpads, touchscreens, keyboards, controllers, and so forth. The power source 310 can be any suitable source for providing power to the various components of the computing device 300, including line and battery power. In the depicted example, the device 300 includes a network interface 312. Such a network interface 312 may allow communication with other devices on a network using one or more communication protocols. In the depicted example, the device 300 includes a user interface 314, such as a display that may display images or data provided by the one or more processors 302. The user interface 314 may include, for example, a monitor, a display, and so forth. As will be appreciated, in a real-world context a processor-based system, such as the computing device 300 of FIG. 4, may be employed to implement some or all of the present approach, such as performing the functions of the mobile device 34, the server 38, and/or the computing device 104, or some other device within the amusement park 10 shown in FIGS. 1 and 2, as well as other memory-containing devices.

FIG. 5 is a flow chart illustrating an embodiment of a process 400 for facilitating a storytelling experience. At 402, the process 400 receives data. As previously described, and as shown in FIG. 5, the data may include description data 404, context data 406, and media 408. Description data 404 is representative of speech describing an experience and may include data collected from microphones, imaging systems, and/or other data collection systems from a guest describing an experience while in the storyteller’s lounge or a storyteller’s booth. In some embodiments, the guest may be prompted by a storytelling guide (e.g., an employee of the amusement park), written prompts (e.g., displayed on a screen, on a wall, on a sign, etc.), audio prompts (e.g., played over a speaker), visual prompts (e.g., displaying images associated with certain attractions or features of the amusement park, which may include photos, videos, audio files, and other data from imaging systems within the park and/or from the guest’s mobile device) may be displayed to prompt the guest to describe an experience, or the guest may begin speaking without prompting. The description data 404 may be collected from the guest’s current visit to the storyteller’s lounge or storyteller’s booth as the process 400 is being performed or from a previous visit to the storyteller’s lounge or storyteller’s booth. The description data 404 may include, for example, audio data, video data, location/movement data, transcripts, and so forth. The context data 406 may include data collected during the guest’s visit to the amusement park. For example, the context data 406 may include what attractions the guest visited and, in some cases, timestamps for those visits, the order of attractions visited, shows attended, orders for food, merchandise, etc. The media 408 may include photos, videos, audio, and other media of the guest captured by imaging systems within the amusement park, as well as photos, videos, audio, and other media from the guest’s mobile device provided or otherwise made accessible by the guest via the application. It should be understood, however, that embodiments are envisaged in which the received data includes only one or two of the data types shown in FIG. 5, and/or includes other types of data.

At 410, the process 400 performs a voice analysis and/or NLU on the received data. For example, the process 400 may utilize voice analysis and/or NLU algorithms (e.g., artificial intelligence-based algorithms) and/or rule sets to receive audio from the guest speaking, a transcription of the guest speaking, and/or other data collected while the guest is speaking and determine the semantic meaning of what the guest is saying. The voice analysis and/or NLU may include, for example identifying people, places, things, attractions, amusement park features, etc. that the guest describes and identifying what the guest is saying about the identified things, such as whether the guest enjoyed something, did not enjoy something, was surprised by something, was scared by something, did not understand something, and so forth. Accordingly, the processes 400 may be capable of customizing and/or tailoring generated visualizations to include people, places, things, attractions, amusement park features, etc. identified in the guest’s speech.

At 412, the process 400 performs a sentiment analysis on the received data. For example, the process 400 may utilize one or more algorithms (e.g., artificial intelligence-based algorithms) and/or rule sets to receive audio from the guest speaking and/or other data collected while the guest is speaking and determine the sentiment of the guest as the guest is speaking (e.g., what are the feelings of the guest being communicated as the guest speaks). Determining sentiment may be based on words used, tone of voice, intonation, other noises made, and so forth. For example, the process 400 may determine whether the guest is happy, sad, excited, scared, nervous, anxious, sarcastic, playful, bored, etc., and in some cases determine the degree to which the guest is expressing identified emotions. For example, the process 400 may be capable of determining a degree of excitement as the guest is speaking and adjust the generated visualizations and/or audio to reflect the emotions being communicated and the degree of those emotions. The process 400 may also identify a climax of the guest’s description, important events in the guest’s description, a priority of events being discussed, and so forth.

At 414, the process 400 performs a gesture analysis on the received data. For example, the process 400 may apply one or more algorithms (e.g., artificial intelligence-based algorithms) and/or rule sets to analyze video data or other imaging data captured by one or more imaging systems and related to movements of the guest to identify gestures and/or other movements of the guest. Gestures may supplement the meaning of what the guest says determined at 410 and/or the sentiment determined at 412. For example, increasing arm movement of the guest or the guest jumping as they speak may be indicative of increased excitement.

The received data 404, 406, 408, as well as the outputs from the voice analysis/NLU 410, the sentiment analysis 412, and/or the gesture analysis 414 may be provided as an input to one or more LLMs 116. As previously described, the process 400, via the one or more LLMs 116, may be configured to generate one or more visualizations and/or audio 418 to be projected in the storyteller’s lounge. The visualizations 418 may incorporate colors associated with the attraction being described by the guest, images of characters, objects, icons, or other imagery associated with the attraction being described by the guest, and/or reflect the sentiment being used by the guest. The visualizations 418 may also include images or video of the guest at the attraction provided by the guest’s mobile device, or captured by imaging systems within the amusement park. The visualizations 418 may incorporate stock images, videos, animations, templates, and so forth that may be associated with the attraction or other aspects of the amusement park. The LLM 116 may also generate audio 418 to be played with the visualizations. The audio 418 may correspond to the sentiment used by the guest (e.g., suspenseful, building to a crescendo, joyful, elegant, etc.) and include audio (e.g., excited screams from a roller coaster) from video provided by the guest’s mobile device or captured by imaging systems in the amusement park, as well as audio files provided by the guest’s mobile device. As previously described, at 420, the audio and visualizations 418 created by the LLM 116 may be shown on the one or more displays and projected by the speakers in the storyteller’s lounge as the guest is describing their experience. In some embodiments, outputs from the LLM 116 may be further processed by the computing device to generate the visualizations and/or audio before the visualizations and/or audio and projected into the storyteller’s lounge.

At 422, the process 400 may also generate one or more keepsakes 424 for the guest to take as a memento to remember their visit to the amusement park. For example, the process 400 may generate a video file that includes the visualizations and/or audio 418. The visualizations and audio 418 may be the same visualizations and audio 418 projected in the storyteller’s lounge at 420 or different from the visualizations and audio 418 projected in the storyteller’s lounge at 420. The video file may or may not include video and/or audio of the guest describing their experience. The video file may be made available to the guest via the application running on the mobile device (e.g., via a server), via a hyperlink, via text or email, via a tangible storage medium (e.g., a disk, a thumb drive, etc.), or some other mechanism, allowing the guest to show or send the video to friends and family, post the video to social media, and so forth. In some embodiments, the keepsake 424 may be one or more images (e.g., a slide show or photo album) that may be accessible via the mobile device or physical printed images. The keepsake 424 may also include a file representing a VR or AR experience or environment. In some embodiments, the keepsake 424 may be a physical object, such as stickers, a calendar, a scrapbook or bound book, a shirt, a hat, a pin, and so forth. Accordingly, the LLM 116 may generate a design for the physical object that is sent to the computing device or a different computing device for printing, stitching, creation, etc.

At 426, the process 400 generates anonymized guest satisfaction data 428. For example, the process 400 may analyze the received collected data 404, 406, 408, as well as the data input to and output from the LLM 116 to identify what the guest did during their visit to the amusement park, how the guest felt about things the guest did during their visit to the amusement park, and, in some cases, the degree of their feelings. For example, if the guest described riding a particular roller coaster and that it was their favorite thing the guest did that day, the process 400 may generate guest satisfaction data 428 that may include a tag for the identified attraction and/or amusement park feature, and a score or rating of the guest’s satisfaction with the attraction or feature. In some embodiments, the generated data may be anonymized to obscure the guest’s identity such that a person with access to the guest satisfaction data 428 would be unable to identify the guest associated with particular guest satisfaction data 428.

The present disclosure is directed to techniques for creating a storytelling experience for a guest visiting an amusement park. During his or her visit to the amusement park, the guest may visit a storyteller’s lounge. Once inside the storyteller’s lounge, the guest describes experiences the guest has had at the amusement park. The experiences may include, for example, rides ridden, attractions visited, characters met, food eaten, and so forth. As the guest speaks, a microphone and/or an imaging system (e.g., a camera) may record audio and/or video of the guest. A computing device receives the audio and/or video of the guest and generates visualizations and/or audio that may be displayed and/or projected within the storyteller’s lounge to enhance the storytelling experience and prompt the guest to continue describing their visit to the amusement park. The computing device may be configured to perform voice analysis and/or natural language understanding (NLU), sentiment analysis, and/or gesture analysis on the audio, video, and/or other data collected as the guest speaks. The computing system may have access to other data that may be used to generate the visualizations and/or audio. For example, the computing device may have access to data collected from a storyteller’s booth, which may be a scaled down version of the storyteller’s lounge that lacks the capability to generate and project visualizations and/or audio, but collects data from a guest describing an experience during their visit to the amusement park. The computing device may also have access to context data, which may include, for example, information related to the guest collected during the guest’s visit to the amusement park, such as when the guest checked into a queue to ride a ride, reserved tickets for a show, ordered for food, merchandise purchases, an order of attractions visited, and so forth. Further, the computing device may have access to media associated with the guest, either from imaging systems in the amusement park (e.g., cameras mounted along rides to capture images of guests riding rides that guests can purchase, cameras carried by photographers to take portraits of groups of guests and/or guests meeting characters), or from photographs, video, and/or audio stored on a guest’s mobile device to which the guest grants access via a mobile application running on the mobile device.

The collected data, as well as the results of various processing operations, may be provided as inputs to a large language model (LLM), which may generate and output the visualizations and/or audio projected in the storyteller’s lounge as the guest speaks. The LLM may also be configured to output one or more keepsakes (e.g., a video, an image, a sticker, a calendar, a book, a shirt, a hat, a pin, and so forth) for the guest to take with them to remember their trip to the amusement park. Further, the LLM may be configured to generate anonymized guest satisfaction data that identifies an aspect of the guest’s visit to the amusement park and an indication of the guest’s satisfaction with the aspect of the visit to the amusement park indicated by the guest’s description.

By utilizing the disclosed techniques, a guest’s experience at the park may be improved by giving the guest an opportunity to reflect on their visit to the amusement park and by projecting audio and/or visualizations that enhance the reflection experience. The guest’s experience may be further improved by providing the guest with a meaningful keepsake to remember their visit to the amusement park and to share with friends and family. Additionally, the disclosed techniques may provide amusement park operators with a way to obtain authentic customer satisfaction data, which can be used to help the operator of the amusement park make improvements to various aspects of the amusement park, further improving guest experiences at the amusement park.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A system for creating a storytelling experience, the system comprising:
a microphone configured to collect data representative of speech;
a display configured to display visualizations;
a speaker configured to play audio; and
a computing device, comprising:
processing circuitry; and
memory, accessible by the processing circuitry and storing instructions that, when executed by the processing circuitry, cause the processing circuitry to perform operations comprising:
receiving, from the microphone, the data representative of the speech;
performing natural language understanding (NLU) on the received data to determine a semantic meaning of the speech;
providing an input to a large language model (LLM), wherein the input comprises the received data, the determined semantic meaning of the speech, or any combination thereof;
receiving, from the LLM, an output comprising a visualization and corresponding audio generated by the LLM based on the input;
causing the visualization generated by the LLM to be displayed via the display; and
causing the audio generated by the LLM to be played via the speaker.

2. The system of claim 1, comprising an imaging system comprising an imaging sensor configured to collect imaging data, wherein the operations comprise:
receiving, from the imaging system, the imaging data; and
performing a gesture analysis on the received imaging data to identify one or more gestures captured in the imaging data;
wherein the input comprises the imaging data, the one or more identified gestures, or any combination thereof.

3. The system of claim 1, wherein the operations comprise receiving, from the LLM, a design for a keepsake to be provided to a guest.

4. The system of claim 3, wherein the keepsake comprises a video, an image, a sticker, a calendar, a book, a shirt, a hat, a pin, or any combination thereof.

5. The system of claim 1, wherein the operations comprise performing a sentiment analysis on the received data to determine a sentiment of the speech, wherein the input comprises the determined sentiment of the speech.

6. The system of claim 1, wherein the operations comprise generating guest satisfaction data based on the received data, the determined semantic meaning of the speech, the determined sentiment of the speech, the output of the LLM, or any combination thereof.

7. The system of claim 6, wherein the guest satisfaction data identifies an aspect of a visit to an amusement park and an indication of a guest’s satisfaction with the aspect of the visit to the amusement park indicated by the speech.

8. A non-transitory computer readable medium storing instructions that, when executed by processing circuitry, cause the processing circuitry to perform operations comprising:
receiving data representative of speech;
performing natural language understanding (NLU) on the received data to determine a semantic meaning of the speech;
performing a sentiment analysis on the received data to determine a sentiment of the speech;
providing an input to a large language model (LLM), wherein the input comprises the received data, the determined semantic meaning of the speech, the determined sentiment of the speech, or any combination thereof;
receiving, from the LLM, a visualization generated by the LLM based on the input; and
causing the visualization generated by the LLM to be displayed.

9. The computer readable medium of claim 8, wherein the NLU comprises applying one or more NLU algorithms or rule sets to the received data to determine the semantic meaning of the speech based on one or more words identified in the speech.

10. The computer readable medium of claim 8, wherein the sentiment analysis comprises applying one or more sentiment-identifying algorithms or rule sets to the received data to determine the sentiment of the speech based on one or more words identified in the speech, tone of voice, intonation, or any combination thereof.

11. The computer readable medium of claim 8, wherein the received data representative of the speech comprises audio data.

12. The computer readable medium of claim 8, wherein the received data representative of the speech comprises a transcript of the speech.

13. The computer readable medium of claim 8, wherein the operations comprise:
receiving context data, wherein the context data is representative of one or more actions performed by a guest during a visit to an amusement park;
wherein the input comprises the context data.

14. The computer readable medium of claim 8, wherein the operations comprise:
receiving media, wherein the media comprises one or more images of a guest captured by an imaging system in an amusement park during;
wherein the input comprises the media.

15. The computer readable medium of claim 8, wherein the operations comprise:
receiving media, wherein the media comprises one or more images of a guest during a visit to an amusement park, wherein the one or more images were captured by a mobile device belonging to the guest;
wherein the input comprises the media.

16. A method for creating a storytelling experience, the method comprising:
receiving an image of a guest having an experience;
receiving data representative of speech describing the experience;
performing natural language understanding on the received data to determine a semantic meaning of the speech;
performing a sentiment analysis on the received data to determine a sentiment of the speech;
providing an input to a large language model (LLM), wherein the input comprises the received image, the received data representative of the speech, the determined semantic meaning of the speech, the determined sentiment of the speech, or any combination thereof;
receiving, from the LLM, a visualization generated by the LLM based on the input, wherein the visualization includes the image; and
causing the visualization generated by the LLM to be displayed via a display.

17. The method of claim 16, comprising:
receiving context data, wherein the context data is representative of one or more actions performed by the guest during a visit to an amusement park;
wherein the input comprises the context data.

18. The method of claim 16, comprising:
receiving, from an imaging system, imaging data from the guest delivering the speech describing the experience; and
performing a gesture analysis on the received imaging data to identify one or more gestures made by the guest;
wherein the input comprises the imaging data, the one or more identified gestures, or any combination thereof.

19. The method of claim 16, comprising receiving, from the LLM, a design for a keepsake to be provided to the guest, wherein the keepsake comprises a video, an image, a sticker, a calendar, a book, a shirt, a hat, a pin, or any combination thereof.

20. The method of claim 16, comprising generating guest satisfaction data based on the received data, the determined semantic meaning of the speech, the determined sentiment of the speech, the visualization generated by the LLM, or any combination thereof, wherein the guest satisfaction data identifies an aspect of a visit to an amusement park and an indication of the guest’s satisfaction with the aspect of the visit to the amusement park indicated by the speech.
